(19) United States
(12) Patent Application Publication
(10) Pub. No.: US 2006/0030389 A1
(43) Pub. Date: Feb. 9, 2006

(54) Gaming machine

(76) Inventor: Kazuo Okada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/184,021

(22) Filed: Oct. 10, 2003

(51) Int. Cl. A63F 9/24

(52) U.S. Cl. 463/16

(57) ABSTRACT

Gaming machine.

### DISCLOSURE OF THE INVENTION

Standards on Gaming Machines Having Risks of Inflaming Speculative Spirits Seriously.

Article 7

Pinball Gaming Machine

I. A gaming machine having a function capable of discharging the number of game balls (Referring to balls to be used for the game. Ditto in this and the following sections.), which correspond to gaming fees of more than four hundred yen per minute.

II. A gaming machine having a function that more than fifteen game balls can be obtained by the winning of one game ball.

III. A gaming machine having a function that more than three times of the number of game balls that are continuously shot for an hour can be obtained. Another gaming machine having a function that remarkably many game balls can be obtained for a short period of time.

IV. A gaming machine having a function that more than twice of the number of game balls that are continuously shot for ten hours can be obtained. Another gaming machine having a function that less than half of the above-mentioned number of game balls can be obtained.

V. A gaming machine having a winning combination device (Referring to a special device to facilitate the winning. Ditto hereinafter.) and having a function that more than about ten game balls can be awarded for the winning while the winning combination device operates.

VI. A gaming machine having a function that a ratio of the number of game balls that can be obtained by the operation of the winning combination device to the total number of game balls that can be obtained when gaming balls are continuously shot for ten hours can be more than seventy percent. Another gaming machine having a function that the ratio thereof can be remarkably high.

VII. A gaming machine being provided with a special device (Referred to as “winning combination continuous operation device”) for operating the winning combination device continuously, and having a function that more than sixteen times the winning combination device operates consecutively. Another gaming machine having a function that remarkably many game balls can be obtained by the operation of the winning combination continuous operation device.

VIII. A gaming machine having a function that a ratio of the number of game balls that can be obtained by the operation of the winning combination continuous operation device to the total number of game balls that can be obtained when gaming balls are continuously shot for ten hours is more than sixty percent.

IX. A gaming machine having much larger or much smaller open mouth for the winning than the size of the game ball. Another gaming machine that makes a player obtain game balls with ease or with difficulty irrespective of skills of the player.

X. A gaming machine capable of shooting a game ball without any direct operation by a player. A gaming machine being incapable of adjusting a position of the game ball on a game panel irrespective of skills of the player. A gaming machine having a function that a winning combination device can be activated remarkably with ease. A gaming machine having a function that the gaming machine can be adjusted to undermine fairness of the game. A gaming machine having a serious risk that the skills of the player may not appear in the result or that the result of the game is determined either by chance or by intention of a third party other than the player.

XI. A gaming machine having a risk that unjust changes or other modifications of the gaming machine can easily be mad.

Rotary Drum Type Gaming Machine

I. A gaming machine having a function capable of allowing a player to play a game by using the number of game medals (Referring to medals to be used for the game. Ditto in this and the following sections.) or game balls (collectively hereinafter being referred to as “game medal etc.”), which correspond to gaming fees of more than four hundred yen per minute.

II. A gaming machine having a function that more than fifteen game medals or more than seventy five game balls can be obtained by one winning, or more than fifteen times of the number of game medals etc. having been used for the winning can be obtained.

III. A gaming machine having a function that more than three times of the number of game medals etc. having been used continuously for four hundred plays of the game can be obtained. Another gaming machine having a function that remarkably many game medals etc. can be obtained for a short period of time.

IV. A gaming machine having a function that more than one and half times of the number of game medals etc. having been used continuously for six thousand plays of the game can be obtained.

V. A gaming machine having a function that more than one and one-fifth times or less than eleven-twentieths of the number of game medals etc. having been used continuously for seventeen thousand five hundred plays of the game can be obtained.

VI. A gaming machine having a winning combination device and having a function that more than eight winnings can be obtained, if the winning combination device operates.

VII. A gaming machine having a function that a ratio of the number of game medals that can be obtained by the operation of the winning combination device to the total number of game medals that can be obtained when gaming medals are continuously used for six thousand plays of the game can be more than seventy percent. Another gaming machine having a function that the ratio thereof can be remarkably high.

VIII. A gaming machine provided with a winning combination continuous operation device andhaving a function that the number of game medals etc. to be obtained by the single operation of the winning combination continuous operation device is more than four hundreds and eighty game medals and two thousands and four hundreds game balls, respectively.

IX. A gaming machine having a function that a ratio of the number of game medals that can be obtained by the operation of the winning combination device (excluding the operation to be made to end when one game result is obtained) to the total number of game medals that can be obtained when gaming medals are continuously used for six thousand plays of the game can be more than seventy percent.

X. A gaming machine having remarkably many or few symbol combinations of winning on a rotary drum. Another gaming machine that makes it easy or difficult for the player to obtain the game medals etc. irrespective of skills of a player.

XI. A gaming machine being incapable of adjusting rotation of a rotary drum irrespective of skills of a player. A gaming machine having a remarkably fast rotation of the rotary drum. A gaming machine having a function that the winning combination can be activated remarkably with ease. A gaming machine having a function that adjustment of the gaming machine can undermine the fairness of the game. A gaming machine having a serious risk that skills of the player may not appear in the result or that the result of the game is determined either by chance or by intention of a third party other than the player.

XII. A gaming machine having a risk that unjust changes or modifications can be easily made.

Arrange Ball Gaming Machine

I. A gaming machine having a function capable of allowing a player to play with the number of game balls etc. (Referring to “game balls” defined in the law Article 23, paragraph 1, section 3. Ditto herein after.) corresponding to game fees of about four hundred yen per minute.

II. A gaming machine having a function that more then fifteen times of the number of game balls etc. having been used for one winning can be obtained.

III. A gaming machine having a function that more than three times of the number of game balls etc. having been continuously used for one hour can be obtained. Another gaming machine having a function that remarkably many game balls etc. can be obtained for a short time period.

IV. A gaming machine having a function that more than twice or less than half of the number of game balls etc. having been continuously used for ten hours can be obtained.

V. A gaming machine having a function that a ratio of the number of game balls etc. that can be obtained by the operation of the winning combination device and a point increasing device (referring to a device that increases the number of game balls etc. which can be obtained by the winning) to the total number of game balls etc. that can be obtained when games are continuously played for ten hours can be more than seventy percent. Another gaming machine having a function that the ratio thereof can be remarkably high.

VI. A gaming machine having remarkably many or few symbol combinations of winning on a game panel. Another gaming machine that make it easy or difficult for a player to obtain the game balls etc. irrespective of skills of the player.

VII. A gaming machine capable of shooting game balls (Referring to balls to be used for the game. Ditto in this section.) without any direct operation by a player. A gaming machine being incapable of adjusting a position of the game ball on the game panel irrespective of skills of the player. A gaming machine in which the positions of the game balls on the game panel cannot be recognized. A gaming machine having a function that unjust changes or modifications that undermine fairness of the game can be made. A gaming machine having a serious risk that the skills of the player may not appear in the result or that the result of the game is determined either by chance or by intention of a third party other than the player.

VIII. A gaming machine having a risk that unjust changes or modification ca be made easily.

Jan-Ball Gaming Machine

I. A gaming machine having a function capable of allowing a player to play with more than the number of game balls etc. corresponding to game fees of about four hundred yen per minute.

II. A gaming machine having a function that more than fifteen times of the number of game balls etc. having been used for the winning can be obtained by one winning.

III. A gaming machine having a function that the number of game balls etc. to be obtained by the operation of the winning combination device is remarkably larger than that to be obtained without the operation of the winning combination device.

IV. A gaming machine having a function that the winning combination device can be activated intensively for a short period of time. Another gaming machine having a function that remarkably many game balls etc. can be obtained for a short period of time.

V. A gaming machine having remarkably many or few symbol combinations of winning on a game panel. Another gaming machine that makes it easy or difficult for the player to obtain the game balls etc. irrespective of skills of the player.

VI. A gaming machine capable of shooting game balls (Referring to balls to be used for the game. Ditto in this section.) without any direct operation of the player. A gaming machine being incapable of adjusting a position of the game ball on a game panel irrespective of skills of the player. A gaming machine, in which the player cannot recognize a position of the game ball on the game panel. A gaming machine having a function that the winning combination device can be activated remarkably easily. A gaming machine having a function that adjustment which undermines fairness of the game can be made. A gaming machine having a serious risk that the skills of the player may not appear in the result or that the result of the game is determined either by chance or by intention of a third party other than the player.

VII. A gaming machine having a risk that unjust changes or modifications can easily be made.

Other Gaming Machines

I. A gaming machine having a function capable of allowing the player to play with more than the number of game balls etc. corresponding to game fees of about four hundred yen per minute.

II. A gaming machine having a function that more than fifteen times of the number of game balls etc. having been used for the winning or the equivalent numerical value can be obtained by one winning.

III. A gaming machine having a function that remarkably many game balls etc. or the equivalent numerical value can be obtained by operation of a winning combination device.

IV. A gaming machine having a function that a ratio of the number of game balls etc. or the equivalent numerical value to be obtained by operation of a winning combination device to the total number of game balls etc. can be remarkably large.

V. A gaming machine having a function that remarkably many game balls etc. or the equivalent numerical value can be obtained for a short period of time.

VI. A gaming machine that makes it easy or difficult for a player to obtain the game balls etc. or the equivalent numerical value irrespective of skills of the player.

VII. A gaming machine having a serious risk that skills of the player may not appear in the result or that the result of the game is determined either by chance or by intention of a third party other than the player.

VIII. A gaming machine having a risk that unjust changes or other modifications can be made.

[Standards on Game Fees etc.]

Art. 29 (Omitted)

I. (Omitted)

II. (Omitted)

A (Omitted)

B Rotary Drum Type Gaming Machine

The fees are determined respectively according to the following categories of gaming machines:

(1) Gaming Machines Using Balls four yen for each ball; and

(2) Gaming Machine Using Medals twenty yen for each medal.

C Arrange Ball Gaming Machine (limited to those using balls or medals)

(1) Gaming Machine Using Balls four yen for each ball

(2) Gaming Machine Using Medals twenty yen for each medal

D Jan-Ball Gaming Machine (limited to those using balls or medals)

The fees are determined respectively according to the following categories of gaming machines:

(1) Gaming Machine Using Balls four yen for each ball; and

(2) Gaming Machine Using Medals twenty yen for each medal.

E (Omitted)

III. (Omitted)

2 and 3 (Omitted)

[Documents Attached to Request for Authorization]

Art. 1 (Omitted)

I to VI (Omitted)

VII The following documents for a person to make business such as a pachinko parlor according to Art. 7:

A (Omitted)

B The following documents in case a gaming machine (limited to the one which has never been disposed at a place of the business offering food and entertainment) belonging to the type examined under Art. 20, paragraph 4 of the law is to be disposed:

(1) Documents of prima facie evidence that the type of the gaming machine has been examined; and

(2) Documents, as prepared by a manufacturer (Including a person to manufacture the gaming machine abroad for importation to this Country. Ditto in C.) or an importer of the gaming machine, of prima facie evidence that the gaming machine belongs to the type according to the documents (1).

C The following documents in case (excluding cases applying B) a gaming machine belonging to the type examined under Art. 20, paragraph 4 of the law is to be disposed:

(1) Documents of prima facie evidence that the type of the gaming machine has been examined; and

(2) Documents, as prepared by a manufacturer or an importer of the gaming machine or the person who has been acknowledged to have an ability to inspect and handle the gaming machine properly by the Fair Trade Commission, for prima facie evidence that the gaming machine belongs to the type according to the documents (1).

D The following documents on a gaming machine other than those specified in A to C, in case the gaming machine is to be disposed:

(1) to (4) (Omitted)

Attached Second Table: Meanings of Terminologies in Technical Standards (on Art. 6)

(1) Terminologies relating to items shared among a plurality of kinds of gaming machines

The terminologies relating to items shared among a plurality of kinds of gaming machines on the technical specifications specified under Art. 6 are as follows.

A “Main Board” refers to a board having a function which exerts or may exert influences on the result of the game, but excepts a board being provided with electronic parts only for connecting wires with each other.

B “Sub Board” refers to a main board that is provided with neither microprocessor (referring to an integrated circuit constituting a central processing unit in an electric computer) nor read only memory (herein after referred to as “ROM” in the following table).

C “Game Ball Lending Device Connection Terminal Board” refers to a gaming machine terminal board that exclusively connects wires between the gaming machine and a machine or device other than the gaming machine for transmitting a signal to lend game balls, and wires inside the gaming machine.

D “Peripheral Board” refers to a board other than the main board and excepts a board that is provided only with electronic parts for connecting wires with each other.

E “Relay Terminal Board” refers to a gaming machine terminal board that exclusively connects the wires inside the gaming machine with each other.

F “External Terminal Board” refers to a gaming machine terminal board that exclusively connects between the wires inside the gaming machine and the wires between a machine or device (excepting a board for transmitting a signal to lend game balls) other than the gaming machine and the gaming machine.

G “Game Ball” refers to a ball to be used for the game.

H “Gaming Machine Terminal Board” refers to a board that is provided only with electronic parts for connecting the wires with each other.

I “Game Pin” refers to a device having a nail-like shape and providing a change in a direction of a falling game ball.

J “Pinwheel” refers to a device of a bladed wheel tyope for changing a direction falling of a game ball.

K “Game Panel” refers to a plate used in a game panel board.

L “Frame of Game Panel” refers to an outer frame of the game panel board for fixing the game panel board.

M “Game Medal” refers to a medal to be used for the game.

N “Hopper Device” refers to a device for allowing a player, by operating a button or other devices without inserting any medals into the gaming machine, to use a predetermined number of game medals consecutively from accumulated game medals by acquiring game medals through winning of game medals and through prior insertion of game medals into the gaming machine. The hopper device is enabled to record a number with an electromagnetic method, the number being a resulting number from subtractivation of the sum of game medals having used for the game from the sum of the game medals having been inserted into the gaming machine and having been acquired in the game.

(2) Meanings of Terminologies on Pinball Gaming Machine

The terminologies relating to the pinball gaming machine, as listed in Art. 6, paragraph 1, are as follows besides those listed in (1).

A “First Kind of Non-Electric Winning Combination” refers to a winning combination other than an electric winning combination, the non-electric winning combination being activated such that a winning mouth other than a large winning mouth is enlarged in case a game ball enters the winning mouth.

B “Maximum Winning Number” refers to a maximum number of game balls, which enter the winning mouth opened or enlarged by a single activation of the winning combination.

C “Second kind of non-electric winning combination” refers to a winning combination other than the electric winning combination, the second kind of non-electric winning combination being activated such that a winning mouth other than a large winning mouth is opened or enlarged in case a game ball enters a specific winning mouth other than the winning mouth or passes through a specific gate.

D “Large Winning Mouth” refers to a winning mouth that facilitates winning remarkably in case the winning combination is activated.

E “Ordinary Electric Winning Combination” refers to an electric winning combination causing that a winning mouth other than a large winning mouth is opened or enlarged, the ordinary electric winning combination being activated in case a game ball enters a specific winning mouth or passes through a specific gate, or a specific symbol combination is displayed.

F “Ordinary Symbol Display Device” refers to a device for displaying a symbol combination to activate the ordinary electric winning combination.

G “Special Electric Winning Combination” refers to an electric winning combination that opens or enlarges the entrance of the large winning mouth.

H “Winning Combination Continuous Activation Device” refers to a special device for activating the special electric winning combination.

I “Conditional Device” refers to a device, the activation of which is a condition necessary for activating the winning combination continuous activation device, the device being activated in case a specific symbol combination is displayed or in case a game ball (excepting the game ball having entered the large winning mouth having been opened or enlarged while the winning combination continuous activation device being activated) passes through a specific region in the large winning mouth.

J “Special Symbol Display Device” refers to a device for displaying the special electric winning combination and the combination of symbols to activate the conditional device.

K “Start Mouth” refers to a winning mouth relating to a win of the game ball for activating either single predetermined specific electric winning combination or single predetermined special symbol display device.

L “Activation Probability” refers to a probability of displaying a symbol combination to activate the conditional device.

M “Holding Device” refers to a device for dropping the game balls having been held toward a winning mouth other than the large winning mouth.

N “Receiving Tray” refers to a device for receiving game balls acquired by winning and other game balls than game balls staying on the game panel.

(3) Meanings of Terminologies on Rotary Drum Type Gaming Machine

The terminologies relating to the rotary drum type gaming machines, as listed in Art. 6, paragraph 2, areas follows besides those listed in (1).

A “Re-Game” refers to a game which can be played without inserting (including the use of the game medals etc. for a play by operating a button relating to a holding device or another device, as also applied to this and other fifth, sixth and seventh tables) a game medal or a game ball (being referred to as “game medal etc.” in this table and sixth and seventh separate tables).

B “Drum Rotating Device” refers to a device to be activated by operating the button, lever or another device belonging to the gaming machine, for rotating the drum.

C “Winning” refers to display of a predetermined symbol combination as a necessary symbol combination for winning the game medals etc.

D “Conditional Device” refers to a device, the activation of which is a condition necessary for displaying the symbol combination relating to the winning, a re-game, a winning combination or the activation of the winning combination continuous activation device, and is activated in case a lottery (being referred to as “internal lottery” in this table and third and fifth separate tables) in the gaming machine by an electronic computer is acquired.

E “Setting” refers to a combination of probabilities that the individual conditional devices relating to the activation of the winning, re-game and winning combination, or the activation of the winning combination continuous activation device are activated according to a specified number (as determined for the individual kinds of games as the number of game medals etc. to be inserted for acquiring one game result. Ditto in G and I of (3) and fifth separate table).

F “First Kind Special Winning Combination” refers to a winning combination either for increasing the number of symbol combinations relating to a winning for every specified number or for raising the probability of activation of the conditional device relating to the winning for every specified number, and can be activated in a predetermined case to continue the activation till the result of the games of no more than 12 times is obtained.

G “Winning Combination Continuous Activation Increasing Device” refers to a device, which can activate the fifth kind of special winning combination and the second kind of special winning combination continuously, and is activated, in case a specific symbol combination is displayed, and terminates the activation in a predetermined case.

H “Ordinary Winning Combination” refers to a winning combination either for increasing the number of symbol combinations relating to a winning for every specified number or for raising the probability of the activation of the conditional device relating to the winning for every specified number, and activation, in case a specific symbol combination is displayed, and terminates the activation in case the result of one play of the game is obtained.

I “Second Kind of Special Winning Combination” refers to a winning combination for activating a conditional device relating to a winning irrespective of the result of an internal lottery, and is activated in a predetermined case and terminates the activation in case the result of one play of the game is obtained.

J “Frame of Gaming Machine” refers to an outer frame of the gaming machine for fixing the rotary shaft of the drum.

K “Receiving Tray” refers to a device for receiving the game medals etc. acquired by the winning and other game medals etc. than inserted game medals.

L “Setting Changing Device” refers to a device for changing the setting, and is activated by operating a button, lever or another device belonging to the gaming machine.

(4) Meanings of Terminologies on Arrange Ball Gaming Machine

The terminologies relating to the arrange ball gaming machines, as listed in Art. 6, paragraph 3, areas follows besides those listed in (1).

A “Winning” refers to a display of a specific symbol combination necessary for winning the game medals etc.

B “Score Increasing Device” refers to a device for increasing the number of game medals etc. to be acquired by a winning, and is activated in case a game ball enters a specific winning mouth or passes through a specific gate.

C “Winning Symbol Display Device” refers to a device for displaying the symbol combination relating to the winning.

D “Introduction Increasing Device” refers to a device for increasing the number of combinations of winning mouths, gates or symbols of the case, in which a winning combination introduction device is activated as a result that the game ball has entered the winning mouth or has passed through the gate or that the combination of symbols has been displayed, and is activated in case the game ball passes through the activation region of the introduction increasing device.

E “Winning Combination Introducing Device” refers to a device for opening or enlarging the entrance of the winning mouth, and is activated in case the game ball enters a predetermined winning mouth or passes through a predetermined gate or in case a predetermined symbol combination is displayed.

F “Introduction Symbol Display Device” refers to a device for displaying the symbol combination for activating the winning combination introducing device.

G “Winning Combination Activating Mouth” refers to a winning mouth relating to a ball entry for activating the winning combination.

H “Introduction Increasing Device Activating Region” refers to a specific region in a specific winning mouth.

I “Specific Winning Mouth” refers to a winning mouth having an introduction increasing device activating region therein.

J “Receiving Tray” refers to a device for receiving the game medals etc. acquired by a winning and other game medals etc. than game medals on the game panel.

(5) Meanings of Terminologies on Jan-Ball Gaming Machine

The terminologies relating to the jan-ball gaming machines, as listed in Art. 6, paragraph 4, areas follows besides those listed in (1).

A “Automatic Symbol Setting Device” refers to a device for automatically setting the symbol combination to be displayed in the symbol display device by inserting a specified number of game medals etc. (i.e., the number of game medals etc. needed to be inserted for activating the gaming machine. Ditto in sixth and seventh separate tables).

B “Winning” refers to display of a specific symbol combination as a necessary symbol combination for winning the game medals etc.

C “Score Increasing Device” refers to a device for increasing the number of game medals etc. to be acquired by a winning, and is activated in a predetermined case.

D “Opening Condition Device” refers to a device having an activation necessary for opening a special winning mouth, and is activated in case a predetermined symbol combination relating to the winning is displayed.

E “Special Winning Mouth” refers to a winning mouth, the entrance of which is opened in case a game ball enters a specific winning mouth or passes through a specific gate.

F “Conditional Continuing Device” refers to a device for activating the opening condition device continuously, and is activated in case a predetermined symbol combination for activating the opening condition device is displayed.

G “Symbol Display Device” refers to a device for displaying the symbol combination relating to the winning.

H “Receiving Tray” refers to a device for receiving game medals etc. acquired by a winning and other game medals etc. than game medals staying on the game panel.

[Procedures of Request for Approval]

The person to request the approval (hereinafter being referred to as “approval” excepting Item 3-2, B(3)) of Art. 1, Item 20-2 of the Law relating to regulations of the business offering food and entertainment and proper business thereof (hereinafter being referred to as “Law”) has to submit a request for approval of Format No. 1 to the Public Safety Commission in each prefecture (being referred to as “Public Safety Commission”) having jurisdiction over the place of the business.

2 (Omitted)

3 The request for approval has to be accompanied with the following documents.

I (Omitted)

II In case a approval is requested on the gaming machine (excepting that specified above) belonging to the type which has been subjected to the examination (being referred to as “examination”) of Art. 20, Item 4, the following documents have to be submitted.

A Copy of Examination Notice (No. 1) specified in Art. 9, Item 1.

B The document prepared by any of the following persons (of which (2) or (3) has to satisfy the requisites specified in the following item) and providing a prima facie evidence that the gaming machine at issue belongs to the type relating to the Examination Notice (No. 1).

(1) The manufacturer (including a person manufacturing the gaming machine in such a foreign country to be imported to this Country. Ditto in the following.) or importer of the gaming machine at issue.

(2) Either a person who does maintenance and management business of the gaming machine or an employee thereof (only the employee in case the person is a legal entity), and for engagement in the inspection and handling of the gaming machine.

(3) The manager of Art. 24, Item 1 of the law relating to business offering food and entertainment who has received the approval according to Art. 10-2, Item 1.

III (Omitted)

4 The requisites on the person capable of inspecting and handling the gaming machine properly are as follows.

I The person listed in the preceding Item 2, B (2) has to fall under any of the following items.

A The person admitted by the Public Safety Commission to have sufficient knowledge and skills on the inspection and handling of the gaming machine, and to perform the inspection and handling of the gaming machine properly.

B The person not falling under any of the following items.

(1) The juvenile;

(2) The person falling under any of Art. 4, Item 1-1 to 1-7-2;

(3) The person having done additional installations, exchanges and other modifications of gaming machines in violation of Art. 9, Item 1, as applied to Art. 20, Item 10, without approval of the Public Safety Commission, and five years have not elapsed yet from the date of the person's action;

(4) The person having done the reception of approval of Art. 9, Item 1, as applied to Art. 20, Item 10, by a false or unlawful means, and five years have not elapsed yet from the date of the person's action;

(5) The person (if legal entity, an executive of the legal entity on the date of cancellation) having been canceled in the approval of examination according to the regulation Art. 11, Item 2, and five years have not elapsed yet from the date of said cancellation;

(6) An employee of the person of business falling under any of (2) to (5); and

(7) An employee of the legal entity having the executives who fall under any of (2) to (5).

II The person listed in the preceding Item 2, B (3) has to fall under any of the following items.

A The person admitted by the Public Safety Commission to have sufficient knowledge and skills on the inspection and handling of the gaming machine, and to perform the inspection and handling of the gaming machine properly.

B The person not falling under any of the foregoing B (3) to (5).

5 The items of Item 3-3, A should be prepared for the pinball gaming machine according to another format No. 2, for the rotary drum type gaming machine according to another format No. 3, for the arrange ball gaming machine according to another format No. 4, for the jan-ball gaming machine according to another format No. 5, and for another gaming machine by describing items according to the items of those formats.

[Requirement for Amendment on Request for Approval]

Art. 1-2 The Public Safety Commission can require, in case the request for approval or the documents to accompany that request are insignificantly defective (e.g., clerical errors or omissions, from which the items the person (hereinafter being referred to as “requester”) having submitted the request intended to write can be easily understood), the requester in writing to make amendments by stating a due period.

[Tests etc. of Approval]

Art. 2 The Public Safety Commission check, if necessary for the approval, on the gaming machine (excepting the gaming machine having been tested according to Art. 13) relating to the request for approval: whether or not the gaming machine at issue falls under the standards (hereinafter being referred to as “Standards of gaming machine”) specified Art. 7 of the Enforcement Rules (Rule Item 1 of the Public Safety Commission, 1985) of regulations of business offering food and entertainment and proper business thereof; and whether or not the gaming machine falling under the kinds of the gaming machines listed under Art. 6, Individual Items satisfies the technical standards specified in the tables of the same Art. and Items (same in the following item and Art. 14, Item 2) in accordance with the kind of the gaming machine, and perform the tests (i.e., the tests by the method according to the method defined in that table for the gaming machine other than those falling under the kinds listed under Art. 6, Individual Items, as in Art. 14, Item 2) according to the methods determined in another first table.

2 When the Public Safety Commission admits, on the approval relating to the gaming machine having been subjected to the gaming machine tests specified under Art. 13, that it is impossible to judge, with only the documents listed under Art. 1, Item 3-1, whether or not the gaming machine at issue falls under the standards of the gaming machine, the Public Safety Commission can order the authorized test agency (being referred to as “authorized test agency”), as regulated under Art. 20, Item 5, to test the gaming machine at issue again and to report the test results to the Public Safety Commission.

3 The Public Safety Commission can request, if necessary for the approval, the requester to submit the gaming machine at issue or its parts.

[Notice etc. of Approval]

Art. 3 The Public Safety Commission shall approve when they admit that the gaming machine relating to the request for approval does not fall under the Standards of the gaming machines (when the Public Safety Commission admit that the gaming machine falling under the kinds of the gaming machines listed under Art. 6, Individual Items satisfies the technical standards specified in the tables listed under the same Article, Individual Items, in accordance with the kind of that gaming machine).

2 The Public Safety Commission notifies the requester of the approval in the written approving notice of another format No. 6.

3. The Public Safety Commission notifies the requester of the non-approval in the written non-approval notice of another format No. 7.

4. In case the request for approval or the documents to be attached to that request are defective (excepting the case, in which the amendment according to the regulation of Art. 1-2 has been made in response to the requirement for said amendment) or in case false descriptions are made in those documents, the gaming machine according to said request for approval is construed in connection with the approval to fall under the standards of the gaming machine (or, for the gaming machines which fall under those described in the items of the Art. 6, to have failed to satisfy the technical standards of Art. 6, Individual Items).

[Cancellation of Approval]

Art. 5 (Omitted)

2 The Public Safety Commission have to give, when they cancel the approval according to the regulations of the aforementioned item, the requester having received that approval a chance for the explanation by notifying the reason in advance. However, this does not apply when the notification is impossible because the residence of the requester having received the approval is unknown.

3 The Public Safety Commission notifies, when they canceled the approval according to the regulation of Item 1, the requester having received the approval of it with a written approval canceling notice of another format No. 8.

[Technical Standards on Type of Gaming Machine]

Art. 6 The technical Standards (being referred to as “technical Standards”) on the types of the gaming machine under Art. 20, Item 3 is determined not only in separate tables No. 2 and No. 3 but also in the tables listed in Individual Items according to the kinds of the gaming machine, as listed in the following items.

Pinball Gaming Machine Separate Table No. 4

2 to 4 (Omitted)

[Procedures of Request for Examinations]

Art. 7 The requester for examination has to submit a request for examinations (being referred to as “request for examination”) of another format No. 9 to the Public Safety Commission having jurisdiction over the place of business, where the gaming machine belonging to said type is to be installed.

2 The request for examination has to be accompanied with the following documents.

I The following documents in case the person (being referred to as “requester for examination”) having submitted said request for examination is personal.

A A copy of a resident card (or a copy of certificate of aliens registration, if the requester is a foreigner).

B A document to swear that the requester is not the person who has been canceled in the examinations according to the regulation of Art. 11, Item 2, and that five years have not elapsed yet from the date of said cancellation.

II The following documents in case the requester is a legal entity.

A Duplicates of certificate of incorporation and registration.

B Document listed in the foregoing B.

C Documents on executives listed in the foregoing A and B.

III The following documents or the copy (three years have not elapsed yet from the date of delivery according to the regulation of the same Item) of confirmation certificate specified under the following Art., Item 3, in case the requester is a manufacturer.

A Documents describing the summary of the manufacturing facilities listed in the lower column of another table No. 8 and the manufacturing ability in accordance with the divisions of the kinds of the gaming machine, as listed in the upper column of the same table.

B Documents describing the summary and the testing ability of either the testing facilities listed in the lower column of another table No. 9 or the testing facilities having equivalent functions in accordance with the divisions of the kinds of the gaming machine, as listed in the upper column of the same table.

C A top plan view of the place of business where the manufacturing facilities of A and the testing facilities of B are to be installed.

D A document describing the summary of the method to manufacture, examine and keep the gaming machine.

E Photographs of the manufacturing facilities of A, the testing facilities of B and the place of business of C, and photographs showing the manufacturing, testing and keeping methods of D.

F A document describing the discovery of a person, who is accepted by the Public Safety Commission as a person capable of properly deciding that the requester for examination can manufacture the gaming machine belonging to the same type.

IV The following documents in case the requester for examination is an importer.

A The documents listed in the foregoing Items A to E relating to the manufacturer of the gaming machine to be imported to this Country.

B The documents listed in the foregoing item B.

C The top plan view of the place of business where the testing facilities of the foregoing item B are to be installed.

D The documents describing the summary of the methods for testing and keeping the gaming machine.

E Photographs of the testing facilities of B and the place of business of C, and photographs showing the testing and keeping methods of D.

F A document describing the opinions of a person, who is accepted by the Public Safety Commission as a person capable of properly deciding that the requester for examination imports the gaming machine belonging to the same type.

V and VI (Omitted)

3 In case the request for examination is to be submitted according to not only the regulations of the foregoing items but also the regulations of Item 1, the request has to be accompanied with five testing gaming machines (although limited to the gaming machines other than those which have elapsed three months after the date of manufacture or importation). However, this does not apply in the case regulated in the foregoing Item, Paragraph 5.

4 The list of items of Item 2, Paragraph 6, A is prepared according to another format No. 2 for the pinball gaming machine, according to another format No. 3 for the rotary drum type gaming machine, according to another format No. 4 for the arrange ball gaming machine, and according to another format No. 5 for the jan-ball gaming machine.

5 The handling explanation of Item 2, No. 6, E has to describe the following items.

1 to 6 (Omitted)

[Confirmation]

Art. 7-2 The manufacturer of the gaming machine can receive confirmation of the Public Safety Commission on that the manufacturer has an ability to manufacture the gaming machine belonging to the same type.

2 The manufacturer to receive the confirmation of the preceding item has to submit a request for conformation (being referred to as “request for confirmation”) of another format No. 10 together with the accompanying documents listed in the preceding Article, Item 2-3 to the Public Safety Commission.

3 The Public Safety Commission deliver the certificate of confirmation (being referred to as “certificate of confirmation”) of another format No. 11 to the manufacturer having made the confirmation of the first item.

4 The manufacturer having received the delivery of the certificate of confirmation has to report, when the contents described in the request for confirmation or in the documents listed in the preceding Article, Item 2-3 were changed, these changes to the Public Safety Commission, within 30 days after the change, in a notice of change of the another format No. 12 (hereinafter being referred to as “notice of change”) together with the documents such ones of the documents listed in the same Item as relate to those changes and as describe the opinions of the person specified in the same Item after the changes.

5 The manufacturer having received the delivery of the certificate of confirmation has to report, when the manufacturer discontinued the manufacture of the gaming machines, the discontinuation in the written report of discontinuation of another format No. 13 to the Public Safety Commission within thirty days from the date of said discontinuation.

6 The Public Safety Commission can cancel the confirmation of the first Item when the manufacturer having received that confirmation falls under any of the following item.

I When it is found that the manufacturer received said confirmation by a false or unlawful means.

II When the manufacturer has not made the report according to the regulations of Item 4 or when it is found that the manufacturer made a false description in the documents relating to said report.

III When it is found that the manufacturer lost the ability to manufacture the gaming machines belonging to the same type.

7 The Public Safety Commission notify, when they canceled the confirmation according to the regulations of the preceding Item, the cancellation to the person having received said confirmation with the notice of cancellation of confirmation of another format No. 14.

[Requirement for Amendment of Examination]

Art. 7-3 The Public Safety Commission can require, in case the request for examination or the documents to accompany that request are insignificantly defective (e.g., clerical errors or omissions, from which the items the requester for examination intended to write can be easily understood), the requester in writing to make a amendment by stating a due period.

[Test of Examination]

Art. 8 The Public Safety Commission performs, when the examination is requested, the test (the examination on said request for examination determined by the type subjected to the type test regulated under Art. 13 and on the documents listed in Art. 7, Item 2-5, as in the following Item) by the method according to another table No. 1 on whether or not the type relating to the request for examinations conforms to the technical standards.

2 When the Public Safety Commission admits, on the examination relating to the type having been subjected to the type test specified under Art. 13, that it is impossible to judge, with only the examination of the foregoing Item, whether or not said type at issue falls under the technical standards, the Public Safety Commission can order the authorized test agency to test said type again (being referred to as “retesting” in the next Article, Item 1) and to report the results to the Public Safety Commission with the retesting instruction of another format No. 15.

3 (Omitted)

[Notice etc. of Examination]

Art. 9 The Public Safety Commission examines, when it is admitted from the result (including the results of the retesting of the same Art., Item 2. Ditto in the following item) of the tests of the preceding Art., Item 1 that the type according to the request for examination satisfies the technical standards, the satisfaction, and not only notify the requester for examination of the satisfaction with the notice of examination (A) of another format No. 16 but also publish that fact.

2 The Public Safety Commission examines, when it is not found from the result of the tests of the preceding Art., Item 1 that the type according to the request for examinations satisfies the technical standards, the dissatisfaction, and notify the requester for examination of the dissatisfaction with the notice of examinations (B) of another format No. 17.

3 In case the request for examination or the documents to accompany the request for examination are defective (excepting the case of the amendment according to the regulation of Art. 7-3 having been made in response to the requirement for the amendment), in case of a false description being made in those documents or in case of serious difficulty in discriminating the name of the type according to the request for examination from that of the type (excepting the type, for which ten years have elapsed from the date of publication according to the regulation of the first item) having received the examinations on the past satisfaction of the technical standards, the type according to said request for examination is construed to dissatisfy the technical standards on the examination.

4 The publication according to the regulation of the first item is performed by posting it on the notice board of the Public Safety Commission for two weeks from the date of notification of the examination and by another suitable method using notes of the Metropolitan Police Office or the Headquarters of Police Regions after said period expired.

[Cancellation of Examination]

Art. 11 (Omitted)

2 The Public Safety Commission can cancel the examination when the person having received the examination corresponds to the following items.

I and II (Omitted)

III When the manuals are not attached in violation of the regulation of the following item or when the manuals attached have contents different from those of the manuals of Art. 7, Item 2, Paragraph 6-E.

IV When a report has not been made or when the report has been false, in case the Public Safety Commission requested the person having received the examination to report with the requirement of report of another format No. 18 within a limit necessary for the enforcement of the canceling regulation.

V (Omitted)

3 The Public Safety Commission has to give, when they cancel the examination according to the regulations of the preceding two items, the requester having received the examination a chance for the explanation by notifying the reason in advance. However, this does not apply when the notification is impossible because the residence of the requester having received the examinations is unknown.

4 The Public Safety Commission notifies, when they canceled the examination according to the regulation of Item 1 or Item 2, the requester having received the examination of it with a written examination canceling notice of another format No. 19, and publish the cancellation by posting it on the notice board of the Public Safety Commission for two weeks from the date of notification of the cancellation of examinations. The Public Safety Commission takes measures for clarifying said cancellation of examination for the publication after the expiration of the publication period according to the regulation of Art. 9, Item 4.

5 The policemen for performing the tests according to the regulation of Item 2, Paragraph 5 have to carry the certificate of another format No. 20 and to post it to the persons concerned.

[Manuals]

Art. 11-2 A gaming machine belonging to the type having received the examination should be accompanied, when it is sold or rent, with manuals having the same contents as those of the manuals of Art. 7, Item 2, Paragraph 6-E.

[Tests of Gaming Machine]

Art. 14 The person to receive the tests of a gaming machine has to submit a request for gaming machine tests (being referred to as “request for gaming machine test”) of another format No. 21 together with documents specified in Art. 1, Item 3, Paragraph 3 and said gaming machine to the authorized test agency.

2 (Omitted)

3 The authorized test agency have to return, when the gaming machine test is completed, the gaming machine at issue quickly to the person (being referred to as “requester for gaming machine test”) having submitted the request for gaming machine test and to deliver the documents having described the results of the gaming machine test.

4 The regulations of Art. 1-2 and Art. 3, Item 4 apply to the gaming machine test. In this case, the “Public Safety Commission” in the Art. 1-2 should be construed as the “authorized test agency”; the “request for approval” as the “request for gaming machine tests”; the “requester for approval” as the “requester for gaming machine tests”; and the “request for approval” in Art. 3, Item 4 as the “request for gaming machine tests”.

[Type Tests]

Art. 15 The person to receive the type tests has to submit a request for type tests of another format No. 22 (being referred to as “request for type test”) together with documents specified in Art. 7, Item 2, Paragraph 6 and five gaming machines for the test specified in Art. 7, Item 3 to the authorized test agency.

2 The authorized test agency can require the person (being referred to as “requester for type test”) having submitted the request for type test, when it admits that the requirement is necessary, for the submission of the parts of the gaming machine to be tested.

3 (Omitted)

4 The authorized test agency deliver the documents describing the results of the type test to the requester for type test, quickly when the type test is terminated.

5 (Omitted)

6 The regulations of Art. 7-3 and Art. 9, Item 3 apply to the type test. In this case: the “Public Safety Commission” in Art. 7-3 should be construed as the “authorized test agency”; the “request for examination” as the “request for type test”; the “requester for examination” as the “requester for type test”; the “request for examination” in Art. 9, Item 3 as the “request for type test”; and “in case of a false description having been made in those documents or in case of serious difficulty in discriminating the name of the type according to the request for examination from that of the type (excepting the type, for which ten years have elapsed from the date of publication according to the regulation of the first item) having received the examination on the past satisfaction of the technical standards” as “in case of a false description being made in those documents”.

7 The authorized test agency has to keep the request for type test, the documents submitted according to the regulation of the first item, and one of the gaming machines submitted according to the regulation of the same item, for six years from the date of the end of the type test. However, this does not apply when it is admitted from the result of the type tests that the type according to the request for type test does not satisfy the technical standards.

[Request for Authorization]

Art. 16 (Omitted)

2 The request for the foregoing item has to be accompanied with the following documents.

I to IV (Omitted)

V The documents describing the names or designation of the members for an incorporated body.

VI The documents describing the name and carrier of the person (being referred to as “examiner”) to execute the game test or type test.

VII The documents verifying that the examiner falls under any of the individual paragraphs of Art. 19, Item 2.

VIII The documents describing the kind and number of machines, instruments and other facilities (being referred to as “testing facilities”) for executing the test works.

[Change of Name etc.]

Art. 17 The authorized test agency has to report, when it changes its name or address or the name or residence of the office for the test works, the change in advance to the Public Safety Commission.

[Authorization]

Art. 17-2 The authorization according to the regulation of Art. 20, Item 5 is made on the persons who are acknowledged to fall under any of the standards listed in the following items.

I The constructions of the executives in a legal entity having been established according to the regulation of Art. 34 of the Civil Law Act (Law No. 89 of Meiji 29) and the members in an incorporated body should not jeopardize the proper and reliable executions of the test works.

II The number of examiners should be more than necessary for the proper and reliable execution of the test works.

III The testing facilities should be established in the kind and number necessary for the proper and reliable execution of the test works.

IV The accounting basis should be made as necessary for the proper and reliable execution of the test works.

[Assignment and Dismissal of Examiner]

Art. 20 The authorized test agency has to submit, when it assigns or dismisses the examiner, a report describing the following items without delay to the Public Safety Commission.

I to III (Omitted)

2 (Omitted)

[Regulations of Test Works]

Art. 21 (Omitted)

2 The items to be decided in the regulations of the test works are as follows.

I to VI (Omitted)

VII The items on the method to deliver the documents describing the results of the type tests or their copies.

VIII The items necessary for executing the test works in addition to the items listed in those individual items.

[Provision etc. of Notes]

Art. 23 The authorized test agency has to prepare and provide the documents describing the results of the gaming machine test or the type test and the notes describing the phrases listed in the following, for every office for the test works, and to keep them for ten years from the date of description.

I The name or designation of the requester for gaming machine test or the requester for the type test.

II to IV (Omitted)

[Suspension/Discontinuation of Test Works]

Art. 27 (Omitted)

[Cancellation of Designation]

Art. 28 The National Public Safety Commission can cancel the designation when the authorized test agency falls under any of the following items.

I When the authorized test agency violates the regulations of Art. 22 and the preceding Article.

II to IV (Omitted)

[Execution of Test Works by the Public Safety Commission]

Art. 29 The Public Safety Commission having made the public announcement according to the regulation of Art. 12, Item 1 performs the test works wholly or partially irrespective of the regulation of Art. 12, Item 2, when the authorized test agency discontinues the test works wholly or partially in response to the approval of Art 27 or when the Public Safety Commission admits it necessary in case the authorized test agency should be disabled by natural disaster or for other reasons to execute the test works wholly or partially.

2 (Omitted)

[Succession etc. of Test Works]

Art. 30 The authorized test agency has to perform the items listed in the following, when it discontinues the test works wholly or partially in response to the approval of Art. 27, when the authorization is canceled according to the regulation of Art. 28, or when the Public Safety Commission performs the test works wholly or partially by themselves according to the regulation of the foregoing Art., Item 1.

I to III (Omitted)

[Procedures with Flexible Disk]

Art. 31 The submissions according to the provision specified in the respective items of the documents listed in the following individual items can be done in place of the submissions of said documents by submitting a flexible disk recorded with the items to be described in said documents and a flexible disk submission sheet according to another format No. 23.

I Request Art. 16, Item 1

II Certificate of incorporation or Act of Endowment
Art. 16, Item 2

III Inventory of property and balance sheet
Art. 16, Item 2

IV Business plan and plan of income and expenditure
Art. 16, Item 2, and Art. 22, Item 1

V Documents describing the names, addresses and brief personal records of executives
Art. 16, Item 2

VI Documents describing the names or designations of employee
Art. 16, Item 2

VII Documents describing the name and career of a examiner
Art. 16, Item 2

VIII Documents verifying that the examiner falls under any of the persons of the individual paragraphs of Art. 19, Item 2

1Art. 16, Item 2

IX Documents describing the kinds and numbers of the testing facilities

Art. 16, Item 2

X Report Art. 20, Item 1

XI Report of business and settlement of accounts

Art. 22, Item 2

2 to 5 (Omitted)

[Specific Device]

Art. 32 The device, as defined by the regulations of the National Public Safety Commission, of the regulations of Table 1 of Art. 10-2 of the Act to Control (the Government Ordinance No. 319 of 1984) relating to the regulations of the business which may affect public morals and the rationalizations etc. of business is an electric winning combination (i.e., the winning combination (i.e., the special device for facilitating the winning, as in the following) which is activated by the electric power, as in the following).

Partial Revision of Rules Relating to Approval of Gaming Machine and Examinations of Type

Rules on Approval of Gaming Machine and Examinations of Type (i.e., Rules No. 4 of the National Public Safety Commission of 1985)

Another Table No. 3

Technical Standards (Art. 6) on Structure of Gaming Machine for Preventing Unlawful Modification and Other Changes

(1) Standards on Board

A The standards on the main board are as follows.

(A) No wiring is made other than that printed on the board face.

(B) No electric part (other than a light emitting diode or another light source mounted on the sub board, or a device for displaying the symbols but not preventing the view to said sub board) is mounted on the two faces of the board.

(C) A transparent case (being referred to as “main board case” in (3)), which is so sealed as leaves traces when it is opened. However, this does not apply to the sub board.

(D) Not the main board capable of receiving the signal transmitted by a machine or device outside the gaming machine, not through a connection terminal board of the game ball lending device.

(E) Not the main board capable of receiving the signal transmitted by the peripheral board.

(F) Not the main board capable of transmitting such a signal to the machine or device outside the gaming machine as may affect the results of the game.

(G) The main board, in which the following items are printed on the board face and displayed by the method for an easy discrimination.

a The name or designation of the manufacturer or importer of the gaming machine.

b The number, symbol or another mark for specifying the type of said main board.

B The peripheral board, in which the number, symbol or another mark for specifying the type thereof is printed on the board face and displayed by the method for an easy discrimination.

C The standards on a relay terminal board are as follows.

(A) No wiring is made other than that printed on the board face.

(B) No electric part is mounted on the two faces of the board.

(C) The relay terminal board at issue, in which the number, symbol or another mark for specifying the type thereof is printed on the board face and displayed by the method for an easy discrimination.

D The standards on an external terminal board are as follows.

(A) No wiring is made other than that printed on the board face.

(B) No electric part is mounted on the two faces of the board.

(C) The external terminal board can be easily taken out from the gaming machine.

(D) Not the external terminal board capable of receiving the signal transmitted by the machine or device outside the gaming machine.

(E) Not the external terminal board capable of transmitting such a signal to the machine or device outside the gaming machine as may affect the results of the game.

(F) The external terminal board at issue, in which the number, symbol or another mark for specifying the type thereof is printed on the board face and displayed by the method for an easy discrimination.

E The standards on the connection terminal board of the game ball lending device are as follows.

(A) No wiring is made other than that printed on the board face.

(B) No electric part is mounted on the two faces of the board.

(C) The connection terminal board can be easily taken out from the gaming machine.

(D) Not the connection terminal board capable of receiving the signal other than the signal transmitted by the machine or device outside the gaming machine and exclusively for lending game balls.

(E) Not the connection terminal board capable of transmitting such a signal to the machine or device outside the gaming machine as may affect the results of the game.

(F) The connection terminal board of the game ball lending device at issue of the game ball lending device, in which the number, symbol or another mark for specifying the type thereof is printed on the board face and displayed by the method for an easy discrimination.

(2) Standards on Electronic Parts Mounted on Main Board

A The standards on the ROM mounted on the main board are as follows.

(A) The ROM can output the contents of the stored information (Including the programs. Ditto in the following table.).

(B) The storage capacity does not exceed 16 KB.

(C) The control area (of the available area (i.e., the storage area of the ROM or the read/write memory storing or be store information other than the necessary information for preventing the unlawful modification or another change. Ditto in the following table.), storage area other than the data area (of the available area, the storage area storing or to store only information other than the programs. Ditto in the following table.) is divided from the data area.

(D) The ROM (excepting that specified in (3) D) relating to the pinball gaming machine and having the control area of a capacity not exceeding 3 KB and the data area of a capacity not exceeding 3 KB.

(E) The ROM (excepting that specified in (3) D) relating to the rotary drum type gaming machine and having the control area of a capacity not exceeding 4.5 KB and the data area of a capacity not exceeding 3 KB.

(F) The ROM (excepting that specified in (3) D) relating to the arrange ball gaming machine and the jan-ball gaming machine and having the available area of a capacity not exceeding 5 KB.

(G) The ROM specified in (3) D having the available area of a capacity not exceeding 2.5 KB.

B The standards on the read/write memory are as follows.

(A) The storage capacity does not exceed 1,024 B.

(B) The capacity of the available area does not exceed 512 B.

C In addition to the standards listed at A and B, the standards on the electronic parts to be mounted on the main board are as follows.

(A) The surface area exceeds about 6 mm².

(B) The internal logic circuit cannot be changed.

(C) Not a custom integrated circuit.

(D) The internal lottery falls under any of the following items.

a The period does not exceed 0.05 sec.

b The period is not regular, and the change for winning that lottery cannot be easily estimated.

(3) Other Standards

A In case the ROM is mounted on the main board, it is mounted by using a socket having a structure not preventing the view to the face of said main board. However, this does not apply in case the electronic parts may not be concealed between said main board and the ROM.

B The electronic parts (excepting the ROM) are mounted on the main board or the gaming machine terminal board by a method not preventing the view to the face of said main board or said gaming machine terminal board.

C The total number of the ROM and the read/write memory mounted on the main board (excepting that regulated under D) does not individually exceed one throughout the main board.

D The total number of the ROM and the read/write memory mounted on the main board for exclusively paying out either the game balls lent or the game medals etc. acquired by a winning to the receiving tray does not individually exceed one throughout the main board.

E The main board (excepting the sub board) is so arranged in the gaming machine that the face having the electronic parts mounted thereon can be easily viewed.

F The main board case allows the view to the two faces of the main board even if it is not opened.

G The main board is not provided with the gaming machine terminal board other than the relay terminal board, the external terminal board and the game ball lending device connection terminal board.

H The main board does not have the structure capable of connecting the wiring between the machine or device outside the gaming machine and the gaming machine with the wiring (excepting the wiring exclusively for feeding the power or for grounding) in the gaming machine not through the external terminal board or the game ball lending device connection terminal board.

I The wiring between the machine or device outside the gaming machine connected with the external terminal board or the game ball lending device connection terminal board and the gaming machine can be easily removed from the gaming machine.

J The main board is not provided with such a device other than the read/write memory to be used for the use other than the use as the activation area as is not used for the game but may affect the results of the game.

Partial Revision of Rules Relating to Approval of Gaming Machine and Examinations of Type

Rules on Approval of Gaming Machine and Examinations of Type (i.e., Rules No. 4 of the National Public Safety Commission of 1985)
   Another Table No. 5

Technical Standards (Art. 6) Relating to Rotary Drum type Gaming Machine

(1) Standards on Performance

A The standards on the gaming machine relating to the rotation of the rotary drum are as follows.

(A) The specified numbers do not exceed three for the game medals and fifteen for the game balls.

(B) The rotations of the rotary drum for achieving the results of the game are performed by activating the rotary drum rotating device after a specified number of game medals etc. are inserted or after the combination of symbols (as will be called the “symbols” in this table) on the drum for the re-game is displayed.

(C) The game medals etc. cannot be newly inserted for the time period from the instant when a specified number of game medals etc. are inserted or when the combination of symbols for the re-game is displayed to the instant when said game medals etc. are inserted or when the result of the game done by the display of the combination of said symbols is obtained.

(D) The directions and speeds of the rotations of all the rotary drums are constant, and the number of rotations should not exceed eighty per one minute. However, this does not apply till the speeds of the rotations of all the rotary drums become constant after the rotary drum rotating device is activated.

(E) A rotation stopping device cannot be activated for the time period after the rotary drum rotating device is activated till the speeds of the rotations of all the rotary drums become constant.

(F) The rotations of the rotary drum should not be stopped within 30 sec. after the speeds of the rotations of all the rotary drums become constant, excepting the case in which the rotation stopping device is activated.

(G) The rotations of the rotary drums stop within 190 ms after a button, a lever or another device (being referred to as “stop button etc.” in this table) for activating the rotation stopping device is operated.

(H) The number of rotary drums is three or more.

(I) The symbols can be substantially recognized even during the activation of the rotary drum rotating device.

B The standards on the performances of the gaming machine relating to the acquisition of the game medals etc. are as follows.

(A) The numbers of game medals etc. to be acquired by one win neither exceed fifteen for the game medals, seventy five for the game balls, respectively, nor exceed 15 times of the number of the game medals etc. used for said winning.

(B) For every regulated numbers, the symbol combination relating to the winning and the number of the game medals etc. to be acquired to correspond to the symbol combination relating to said winning are determined in advance.

(C) The game medals etc. cannot be acquired without the winning.

(D) The combination of symbols relating to the winning is not displayed without the activation of the conditional device relating to the winning.

(E) For every setting and every specified number, all the rotary drums to be rotated after the rotary drum rotating device is activated are tested 400 times by activating the rotation stopping device in an arbitrary order and for an arbitrary time period. In this case, the sum of the game medals etc. acquired does not reach three times as large as the sum of the inserted game medals etc.

(F) For every setting and every specified number, the symbol combination relating to the conditional device is displayed when the internal lottery is made to activate said conditional device, so that the maximum of the game medals etc. to be acquired by said combination of symbols is acquired. In case this simulation tests are performed 400 times, the sum of the game medals etc. acquired does not reach three times as large as the sum of the game medals etc. inserted.

(G) For every setting and every specified number, in case the tests specified in (E) are performed 6,000 times, the sum of the game medals etc. acquired does not reach 1.5 times as large as the sum of the inserted game medals etc.

(H) For every setting and every specified number, in case the simulation test specified in (F) is performed 6,000 times, the sum of the game medals etc. acquired does not reach 1.5 times as large as the sum of the inserted game medals etc.

(I) For every setting and every specified number, in case the simulation test specified in (E) is performed 17,500 times, the sum of the game medals etc. acquired exceeds 11/20 but does not reach 1.2 times as large as the sum of the inserted game medals etc.

(J) For every setting and every specified number, in case the simulation test specified in (F) is performed 17,500 times, the sum of the game medals etc. acquired does not reach 1.2 times as large as the sum of the inserted game medals etc.

(K) For every setting and every specified number, in case the test specified in (E) is performed 6,000 times, the ratio of the game medals etc. by the activations of the winning combinations to those acquired does not reach 70% (or 60% for the ratio by the activations of the first kind of special winning combination).

(L) For every setting and every specified number, in case the simulation test specified in (F) is performed 6,000 times, the ratio of the game medals etc. by the activations of the winning combination to those acquired does not reach 70% (or 60% for the ratio by the activations of the first kind of special winning combination).

(M) The number of the symbol combinations for the winnings exceeds 11/100 of the number of all symbol combinations but not 40/100.

(N) For every setting and every specified number, the probability for one conditional device relating to the winning to activate is a predetermined value and does not fluctuate excepting the case, in which the winning combinations a reactive.

(O) The conditional device relating to the winning is not activated in case the conditional device relating to the re-game is activated. However, this does not apply in case the special winning combination of the second kind is activated.

C The standards relating to the performances of the gaming machine for the re-game are as follows.

(A) For every specified numbers, the re-game cannot be played excepting the next game of the case, in which the specific symbol combination (excepting the symbol combination relating to the winning) is displayed as a result of one play of the game.

(B) The symbol combination relating to the re-game is not displayed without the activation of the conditional device relating to the re-game.

(C) The number of combination of symbols relating to the re-game exceeds 1/145 of the number of all symbol combinations.

(D) For every setting and every specified number, the probability for the conditional device relating to the re-game to act is preset from a value more than 10/73 and does not fluctuate in cases other than the following ones.

a When the conditional device relating to the activation of the special winning combination of the first kind or the winning combination continuous activation device is activated.

b When the symbol combination for the first kind of special winning combination or the winning combination continuous activation device to be activated is displayed.

c When the activation of the first kind of special winning combination or the winning combination continuous activation device ends.

d When a special symbol combination is displayed in case the conditional device relating to the activation of the first kind of special winning combination or the winning combination continuous activation device, the first kind of special winning combination and the winning combination continuous activation device is not activated.

e When the results of a predetermined number of games after either c or d are obtained.

(E) For every setting and every specified number, the probability for the conditional device relating to the re-game to fluctuate is at a preset value (as preset from a value more than 10/73 when the first kind of special winning combination and the winning combination continuous activation device are not activated).

D The standards on the performances of ordinary winning combination are as follows.

(A) No ordinary winning combination is provided except one for being activated in case a special symbol combination is displayed for every specified number.

(B) The symbol combination relating to the activation of the ordinary winning combination is not displayed without the activation of the conditional device relating to the activation of the ordinary winning combination.

(C) For every setting and every specified number, the probability for one conditional device relating to the activation of the ordinary winning combination to act is a predetermined value and does not fluctuate excepting the case, in which the conditional device relating to the first kind of special winning combination or the winning combination continuous activation device, the first kind of special winning combination or the winning combination continuous activation device relating to the first kind of special winning combination is active.

(D) The number of symbol combinations relating to the winning of the case, in which the number of symbol combinations relating to the winning is increased by the activation of the ordinary winning combination, does not exceed ⅓ of the number of all symbol combinations.

(E) The probability of the case, in which the probability for one conditional device relating to the winning to be activated by the activation of one ordinary winning combination is increased is at a predetermined value.

(F) The conditional device relating to the activation of the ordinary winning combination does not act in case another conditional device (excepting those relating the winning and the re-game), the first kind of special winning combination or the winning combination continuous activation device relating to the first kind of special winning combination is activated.

E The standards on the performances of the first kind of special winning combination are as follows.

(A) For every specified number, no other first kind special winning combination is provided than the first kind of special winning combinations being activated in case a special symbol combination is displayed. However, this does not apply in case the winning combination continuous activation device relating to the first kind of special winning combination is activated.

(B) The symbol combination relating to the activation of the first kind of special winning combination is not displayed without the activation of the conditional device relating to the activation of the first kind of special winning combination.

(C) The number of the symbol combinations for the first kind of special winning combination to be activated does not exceed 1/500 of the number of all the symbol combinations for the gaming machine provided with the winning combination continuous activation device, and 3/500 of the number of all the symbol combinations for the gaming machine not provided with the winning combination continuous activation device. However, this dose not apply to the case described in (G) ((H)).

(D) For every setting and every specified number, the probability for one conditional device relating to the activation of the first kind of special winning combination to be activated is a predetermined value and does not fluctuate excepting the case, in which the conditional device relating to another first kind of special winning combination or the winning combination continuous activation device, another first kind of special winning combination or the winning combination continuous activation device relating to the first kind of special winning combination is activated.

(E) The number of symbol combinations relating to the winning of the case, in which the number of symbol combinations relating to the winning is increased by the activation of the first kind of special winning combination, does not exceed ⅓ of the number of all symbol combinations.

(F) The probability of the case, in which the probability for one conditional device relating to the winning to be activated by the activation of one first kind of special winning combination is increased is a predetermined value.

(G) The conditional device relating to the activation of the first kind of special winning combination is not activated, in case another conditional device (excepting those relating the winning and the re-game) is activated or in case another first kind of special winning combination is active (excepting the case, in which the winning combination continuous activation device relating to the first kind of special winning combination is activated).

(H) One first kind of special winning combination ends its activation for the earlier one of the cases, in which a predetermined number of winnings not exceeding eight occur in operation or in which the activation of the winning combination continuous activation device relating to the first kind of special winning combination ends.

F The standards on the performances of the second kind of special winning combination are as follows.

(A) For every specified number, no second kind of special winning combination is provided other than special winning combinations being activated in case a special symbol combination is displayed. However, this does not apply in case the winning combination continuous activation device relating to the second kind of special winning combination is activated.

(B) The combination of symbols relating to the activation of the second kind of special winning combination is not displayed without the activation of the conditional device relating to the activation of the second kind of special winning combination.

(C) For every setting and every specified number, the probability for one conditional device relating to the activation of the second kind of special winning combination to be activated is a predetermined value and does not fluctuate excepting the case, in which the conditional device relating to the activation of the first kind of special winning combination or the winning combination continuous activation device, the first kind of special winning combination or the winning combination continuous activation device is activated.

(D) The conditional device relating to the activation of the second kind of special winning combination is not activated, in case another conditional device (excepting those relating the winning and there-game), the first kind of special winning combination or the winning combination continuous activation device relating to the first kind of special winning combination is activated.

(E) In case the second kind of special winning combination is activated, one or more rotary drums stop within 75 ms. after the stop button or the like is operated.

G The standards on the performances of the winning combination continuous activation device are as follows.

(A) For every specified numbers, no winning combination continuous activation device is provided other than those, which act in case a special symbol combination is displayed.

(B) No winning combination continuous activation device is provided other than those relating to the first kind of special winning combination or the second kind of special winning combination.

(C) The winning combination continuous activation device relating to the second kindof special winning combination is not disposed in the gaming machine other than that specified in (E).

(D) The combination of symbols relating to the activation of the winning combination continuous activation device is not displayed without the activation of the conditional device relating to the activation of the winning combination continuous activation device.

(E) The number of symbol combinations for the winning combination continuous activation device relating to the first kind of special winning combination to be activated does not exceed 2/1,500 of all the symbol combinations for the gaming machine, in which the number of game medals etc. to be acquired during the activation does not exceed 360 for the game medals and 1,800 for the game balls.

(F) The number of symbol combinations for the winning combination continuous activation device relating to the first kind of special winning combination to be activated does not exceed 1/1,500 of all the symbol combinations for the gaming machines other than those specified in (E).

(G) For every setting and every specified number, the probability for one conditional device relating to the activation of the winning combination continuous activation device to be activated is a predetermined value and does not fluctuate excepting the case, in which the conditional device relating to the activation of the first kind of special winning combination or another winning combination continuous activation device, the first kind of special winning combination or another winning combination continuous activation device is activated.

(H) In case the winning combination continuous activation device relating to the first kind of special winning combination is activated, the number of the symbol combinations for the first kind of special winning combination to be activated does not exceed 10/500 of all the symbol combinations.

(I) The probability of the case, in which the probability for one conditional device relating to the activations of the first kind of special winning combination or the second kind of special winning combination to be activated by the activation of one winning combination continuous activation device is increased is a predetermined value.

(J) The conditional device relating to the activation of the winning combination continuous activation device relating to the first kind of special winning combination is not activated, in case another conditional device (excepting those relating the winning and the re-game), the first kind of special winning combination or the winning combination continuous activation device is activated.

(K) The conditional device relating to the activation of the winning combination continuous activation device relating to the second kind of special winning combination is not activated, in case another conditional device (excepting those relating the wins and the re-game), the first kind of special winning combination or the winning combination continuous activation device is activated.

(L) One winning combination continuous activation device relating to the first kind of special winning combination ends its activation, when, in operation, game medals etc. more than one are acquired in such a predetermined number as is selected in advance from the numbers not exceeding 465 for the game medals and 2,325 for the game balls.

(M) One winning combination continuous activation device relating to the second kind of special winning combination ends its activation, either, in operation, when the conditional device relating to the activation of the ordinary winning combination or the first kind of special winning combination is activated or when game medals etc. are acquired in such a predetermined number as is selected in advance from the number not exceeding 253 for the game medals and 1,265 for the game balls.

H Standards on the performances of the hopper device are as follows.

(A) The number of game medals to be recorded does not exceed 50.

(B) The recorded number of game medals is displayed.

(C) The player is allowed to take out the game medals of the recorded number freely.

I The following performances are essential in addition to the performances A to H.

(A) No adjustment can be made detrimental to the fairness of the game.

(B) No winning combination is provided excepting the ordinary winning combination, the first kind of special winning combination and the second kind of special winning combination.

(C) No special device is provided for facilitating the activations of winning combinations other than the winning combination continuous activation device.

(D) The internal lottery is done for the time period from the instant when the rotary drum rotating device is activated to the instant when the rotating speeds of all the rotary drums become constant.

(E) The conditional device ends its activation when one result of the game is obtained. However, the conditional device relating to the activation of the first kind of special winning combination ends its activation earlier of when said first kind of special winning combination is activated or when the winning combination continuous activation device relating to the first kind of special winning combination ends its activation, and the conditional device relating to the activation of the winning combination continuous activation device ends its activation when said winning combination continuous activation device is activated.

(F) The number of setting does not exceed six.

(2) Standards on Structure

A The standards on the structure of the rotary drum rotating device are as follows.

(A) The rotary drum rotating device has such a structure as cannot be activated excepting the case, in which it is directly operated by the player.

(B) The rotary drum rotating device has such a structure as rotates the rotary drums without any fluctuation in operation.

B The standards on the structure of the rotary drums are as follows.

(A) All the rotary drums have an equal size.

(B) All the rotary drums have their axes of rotation on a common straight line.

(C) The number of symbols is not over 21 for one rotary drum and common for all rotary drums. Moreover, the number of the kinds of all symbols is not over 7.

(D) The symbols are clear and can be easily discriminated by the player.

(E) The symbols have a size of 25 mm or more in length and 35 mm or more in width. Moreover, the symbols have an identical size for all the rotary drums according to the kinds of symbols.

C The standards on the structure of the rotation stopping device are as follows.

(A) The rotation stopping device has such a structure as cannot be activated excepting the case, in which the player operates the stop button or the like directly.

(B) The rotation stopping device has such a structure as stops the rotation one rotary drum corresponding to one stop button etc. by operating said stop button etc.

D The frame of the gaming machine has such a structure as fixes the rotating shaft of the rotary drums in order not to easily fluctuate the rotating shaft of the rotary drum.

E The standards on the structure of the glass plate etc. are as follows.

(A) The structure does not obstruct the recognition of symbols.

(B) The structure has no roughness.

F The standards on the structure of the receiving tray are as follows.

(A) The structure allows the player to take out the game medals etc. received by the tray freely.

(B) The structure allows the player to confirm the number of the game medals etc. received by the tray roughly.

G The structure conforms to the following standards in addition to A to F.

(A) The structure has no device lacking the durability.

(B) The structure is not provided with a device detrimental to the recognition of symbols.

(C) The setting changing device has such a structure as cannot be operated by the player.

(3) Standards on Materials

A The standards on the materials of the rotary drums are as follows.

(A) The rotary drums are made of steel or another material so that they may be neither broken nor deformed in shape by rotation.

(B) The shaft of the rotary drums is made of steel or another material so that it may be neither broken nor deformed in shape by rotation or weight of the rotary drums.

B The frame of the gaming machine is made of steel or another material so that it may be neither broken nor deformed in shape by rotation of the rotary drums.

C The glass plate etc. is made of glass or another transparent material.

D The materials of the parts of the gaming machine are not materials to cause any deterioration due to the ordinary change in the temperature or humidity, or deformation in the shape thereof besides materials as described in A to C.

### BRIEF DESCRIPTION OF THE DRAWINGS

FIG. 1 is a perspective view showing the exterior of a gaming machine of an embodiment.

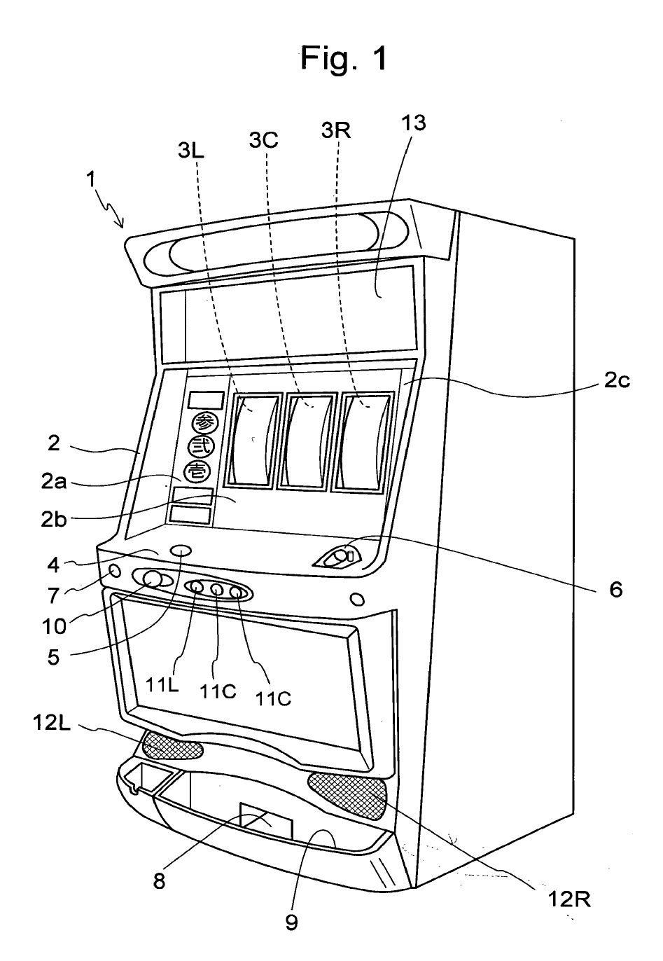

FIG. 2 shows a flow chart illustrating a procedure of a main control circuit of the gaming machine.

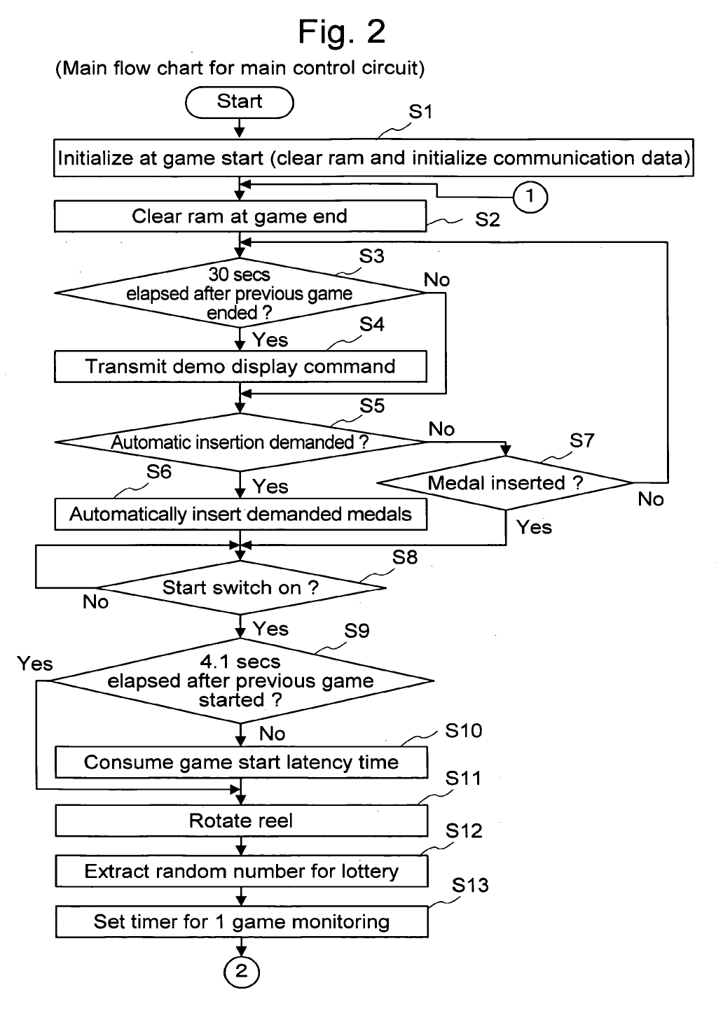

FIG. 3 shows a flow chart illustrating a procedure of the main control circuit of the gaming machine 1 and succeeding to FIG. 2.

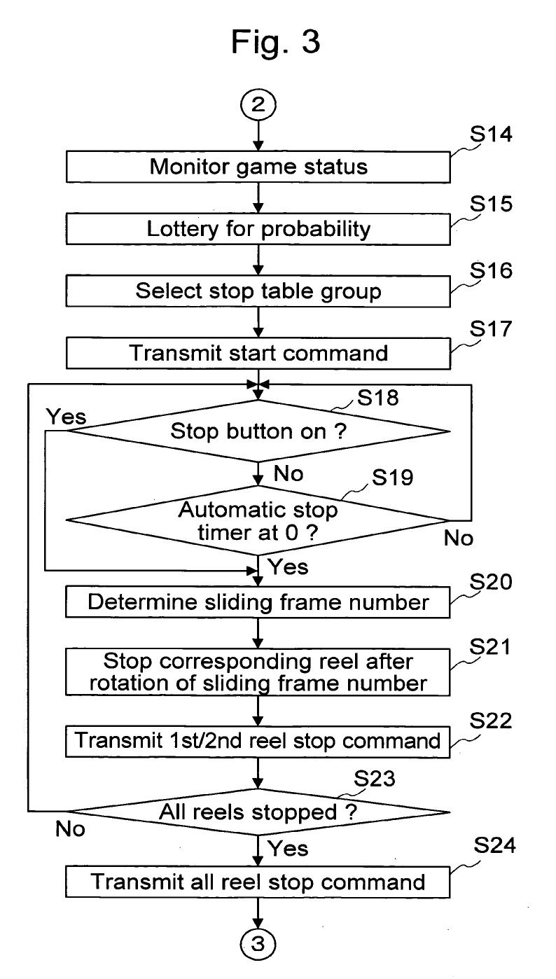

FIG. 4 shows a flow chart illustrating a procedure of the main control circuit of the gaming machine 1 and succeeding to FIG. 3.

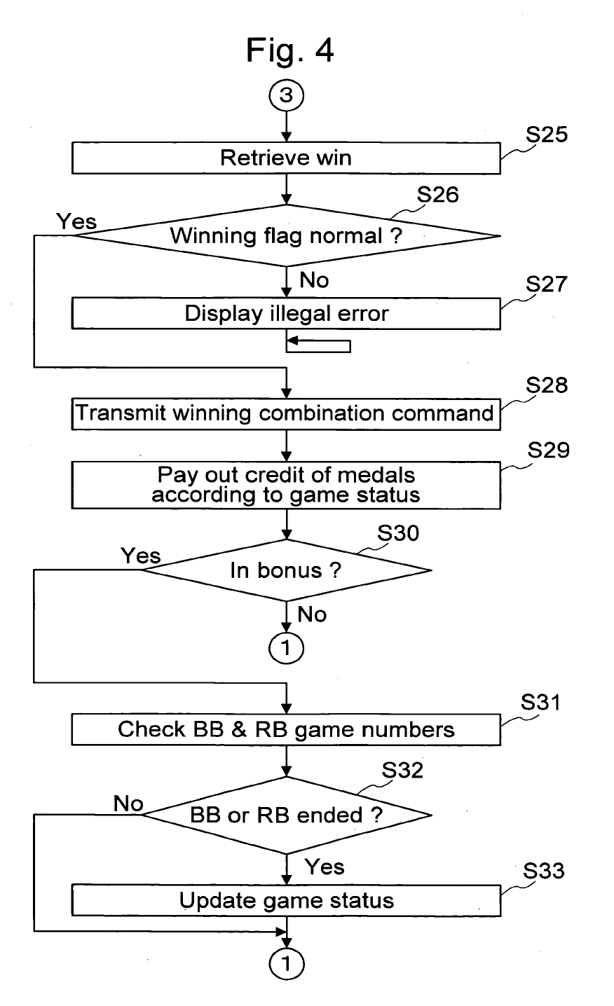

FIG. 5 is a view showing the exterior of a gaming machine of another embodiment.

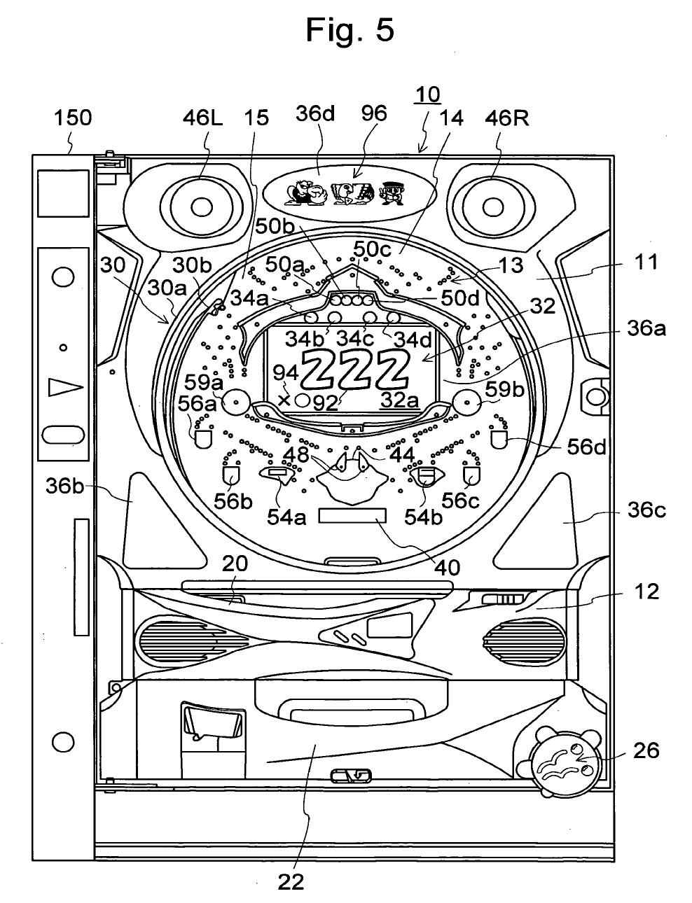

What is claimed is:

1. Gaming machine.
